(19) United States
(12) Patent Application Publication
(10) Pub. No.: US 2026/0086743 A1
(43) Pub. Date: Mar. 26, 2026

(54) MANUSCRIPT SUBMISSION SYSTEM THAT ALLOWS EASY TO PERFORM PRINT SETTING, INFORMATION PROCESSING APPARATUS, AND CONTROL METHOD FOR INFORMATION PROCESSING APPARATUS

(71) Applicant: CANON KABUSHIKI KAISHA, Tokyo (JP)

(72) Inventor: NAO INOUE, Kanagawa (JP)

(21) Appl. No.: 19/311,634

(22) Filed: Aug. 27, 2025

(30) Foreign Application Priority Data
Sep. 25, 2024 (JP) 2024-166125

(51) Int. Cl. G06F 3/12

(52) U.S. Cl. CPC G06F 3/1205; G06F 3/1253

(57) ABSTRACT

A mechanism that allows easy to perform a print setting is provided. A manuscript submission system includes at least one processor, and a memory coupled to the processor storing instructions that, when executed by the processor, cause the processor to function as an accepting unit that accepts, from a user, order information expressing a finish of printing in natural language, an inputting unit that inputs a prompt based on the order information into a large language model, and an outputting unit that outputs information based on a print setting which has been obtained from the large language model using the prompt as an input.

### BACKGROUND

### Field of the Technology

The present disclosure relates to a manuscript submission system, an information processing apparatus, and a control method for the information processing apparatus.

### Description of the Related Art

In recent years, there has been an increase in the number of cases where data is submitted via the Internet when requesting printing at a printing factory. When submitting data, it is necessary for a user to input many setting items as a print setting so that a final product with an intended finish in terms of appearance, material quality, etc. is capable of being obtained. The print setting is complex, and one setting item may affect a plurality of printing areas. For this reason, when a user who is unfamiliar with the submission work (the submission process) performs inputting of the print setting, a final product, which is different from the finish intended by the user, may be generated. As a technique for easily performing such a print setting, for example, a technique disclosure in Japanese Laid-Open Patent Publication (kokai) No. 2020-160947 has been proposed. In the technique disclosure in Japanese Laid-Open Patent Publication (kokai) No. 2020-160947, a print setting is estimated by learning document information and a print setting that have been used during printing and creating a learning model. As a result, it is possible to determine automatically the print setting.

However, in the technique disclosure in Japanese Laid-Open Patent Publication (kokai) No. 2020-160947, it is necessary to set appropriate attribute information in the document information, and in the case where the attribute information has not been set in the document information, the print setting will not be determined automatically. In other words, conventionally, there are cases where a print setting is not capable of being easily performed.

### SUMMARY

The present disclosure provides a mechanism that allows easy to perform a print setting.

Accordingly, a first aspect of the present disclosure provides a manuscript submission system comprising at least one processor, and a memory coupled to the processor storing instructions that, when executed by the processor, cause the processor to function as an accepting unit that accepts, from a user, order information expressing a finish of printing in natural language, an inputting unit that inputs a prompt based on the order information into a large language model, and an outputting unit that outputs information based on a print setting which has been obtained from the large language model using the prompt as an input.

Accordingly, a second aspect of the present disclosure provides an information processing apparatus comprising at least one processor, and a memory coupled to the processor storing instructions that, when executed by the processor, cause the processor to function as an accepting unit that accepts, from a user, order information expressing a finish of printing in natural language, an inputting unit that inputs a prompt based on the order information into a large language model, and a display control unit that controls display of information based on a print setting which has been obtained from the large language model using the prompt as an input.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates an example of a configuration of a manuscript submission system according to an embodiment of the present disclosure.

FIG. 2 is a block diagram that illustrates an example of a hardware configuration of a server PC shown in FIG. 1.

FIG. 3 is a block diagram that illustrates an example of a software configuration of the server PC shown in FIG. 1.

FIG. 4A is a block diagram that illustrates an example of a configuration of a manuscript submission service section shown in FIG. 3, and FIG. 4B is a block diagram that illustrates an example of a configuration of a print setting generating section shown in FIG. 3.

FIG. 5 is a diagram that illustrates an example of an order screen generated by an order screen section shown in FIG. 4A.

FIG. 6 is a diagram that illustrates an example of a preview screen constructed by a preview screen display section shown in FIG. 4A.

FIG. 7A and FIG. 7B are diagrams that illustrate examples of databases managed by an order management section shown in FIG. 4B.

FIG. 8A and FIG. 8B are flowcharts that illustrate the procedure of a print setting save processing executed by the server PC shown in FIG. 1.

FIG. 9A, FIG. 9B, and FIG. 9C are diagrams that illustrate examples of data used in the print setting save processing shown in FIG. 8A and FIG. 8B.

FIG. 10A and FIG. 10B are block diagrams that illustrate an example of a configuration of a manuscript submission system application that is included in the server PC shown in FIG. 1.

FIG. 11A is a flowchart that illustrates one procedure of an input example display control processing by an order example display section shown in FIG. 10B, and FIG. 11B is a flowchart that illustrates another procedure of the input example display control processing by the order example display section shown in FIG. 10B.

FIG. 12 is a diagram that illustrates an example of an order history management database managed by the order management section shown in FIG. 4B.

FIG. 13 is a diagram that illustrates an example of an order screen generated by the order screen section shown in FIG. 4A.

FIG. 14A and FIG. 14B are flowcharts that illustrate the procedure of a print setting correction processing executed by the server PC shown in FIG. 1.

FIG. 15 is a diagram that illustrates an example of a print setting management table managed by a print setting management section shown in FIG. 4B.

FIG. 16 is a flowchart that illustrates the procedure of a processing performed by a print setting generating section 312 in a print setting save processing using a large language model after additional training.

FIG. 17 is a flowchart that illustrates the procedure of a processing performed by a manuscript submission service section 311 in the print setting correction processing executed by the server PC shown in FIG. 1.

FIG. 18A and FIG. 18B are diagrams that illustrate an example of a preview screen displayed on a display that is included in a client PC shown in FIG. 1.

FIG. 19A and FIG. 19B are diagrams that illustrate an example of an order screen generated by the order screen section shown in FIG. 4A.

FIG. 20 is a flowchart that illustrates the procedure of a processing performed by the print setting generating section 312 in the print setting save processing executed by the server PC shown in FIG. 1.

### DESCRIPTION OF THE EMBODIMENTS

The present disclosure will now be described in detail below with reference to the accompanying drawings showing embodiments thereof.

Hereinafter, an embodiment of the present disclosure will be described with reference to the drawings.

It should be noted that the following embodiment does not necessarily limit the present disclosure. In addition, not all of the combinations of features described in the present embodiment are necessarily essential to the solving means of the present disclosure, and a plurality of features may be combined arbitrarily. Furthermore, in the accompanying drawings, the same or similar configurations (components) are given the same reference numerals, and duplicated descriptions will be omitted. In addition, each step in each flowchart is indicated by a reference number beginning with S.

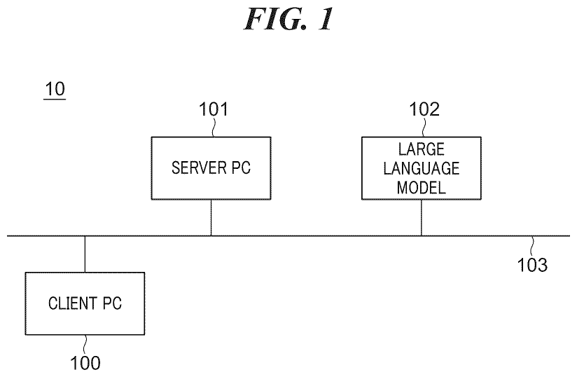

FIG. 1 is a block diagram that illustrates an example of a configuration of a manuscript submission system 10 according to the embodiment of the present disclosure. As shown in FIG. 1, the manuscript submission system 10 includes a client personal computer (a client PC) 100, a server personal computer (a server PC) 101 which serves as an information processing apparatus, and a large language model 102. The client PC 100, the server PC 101, and the large language model 102 are connected to each other via the Internet 103.

The client PC 100 accesses the server PC 101 to perform determining a print setting for obtaining a final product with an intended finish in terms of appearance, material quality, etc., manuscript proofreading, etc.

The server PC 101 is a server for accepting a request from a user when the user uses a printing service that performs printing at a printing factory. The server PC 101 communicates with the client PC 100 that has accessed the server PC 101 and with the large language model 102 via the Internet 103. The server PC 101 obtains order information that has been inputted by the user operating the client PC 100. The server PC 101 inputs a command statement called a prompt, which is generated based on the order information, into the large language model 102, and receives, from the large language model 102, a product generated by the large language model 102.

The large language model 102 (Large Language Models: LLM), based on the prompt that has been received from the server PC 101, generates a product that is highly likely to match (fit) the content of the prompt. The large language model 102 interprets the prompt and generates an appropriate response to the interpreted content. An example of the large language model 102 is the Generative Pre-trained Transformer (GPT (registered trademark)). In the present embodiment, for example, the function of the large language model 102 is provided as a function of a cloud service. It should be noted that in the present embodiment, the LLM is used as the language model, but the present disclosure is not limited to this. It is also possible to use a language model other than the LLM, as long as it is capable of handling and understanding natural language. In addition, a technique such as “ChatGPT (registered trademark of OpenAI)” or “Gemini (registered trademark of Google)” is capable of being adopted as the LLM, but a language model developed independently may also be used as the LLM.

Next, hardware configurations of the client PC 100 and the server PC 101 will be described. It should be noted that in the present embodiment, the client PC 100 and the server PC 101 have the same configuration, and the configuration of the server PC 101 will be described below as an example.

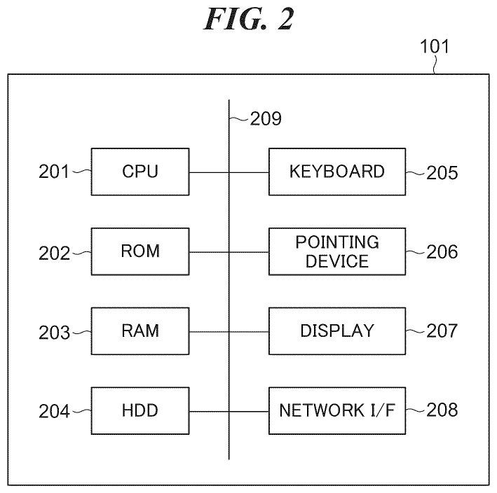

FIG. 2 is a block diagram that illustrates an example of the hardware configuration of the server PC 101 shown in FIG. 1. As shown in FIG. 2, the server PC 101 includes a central processing unit (a CPU) 201, a read only memory (a ROM) 202, a random access memory (a RAM) 203, a hard disk drive (an HDD) 204, a keyboard 205, a pointing device 206, a display 207, and a network interface (a network I/F) 208. The CPU 201, the ROM 202, the RAM 203, the HDD 204, the keyboard 205, the pointing device 206, the display 207, and the network I/F 208 are connected to each other via a bus 209.

The CPU 201 is a central processing unit, and executes processing according to a specified program. The ROM 202 is a non-volatile storage, and retains data and programs that are used in the processes of the embodiments described below. The RAM 203 is a volatile storage, and temporarily retains programs and data. The HDD 204 is a volatile storage, and retains programs and data. It should be noted that the configuration may include another storage device such as a solid state drive (an SSD) instead of the HDD or in addition to the HDD. In the server PC 101, the CPU 201 receives the programs and image data, which have been saved in the ROM 202, the RAM 203, and/or the HDD 204, and performs arithmetic processing.

The keyboard 205 and the pointing device 206 are input devices that are instruction input units. The display 207 is an output device that is a display unit. The network I/F 208 controls the transmission and reception of data to and from the client PC 100 and the large language model 102 via the Internet 103.

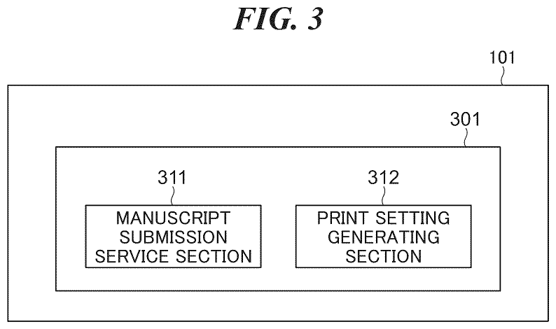

FIG. 3 is a block diagram that illustrates an example of a software configuration of the server PC 101 shown in FIG. 1. As shown in FIG. 3, the server PC 101 includes a manuscript submission system application 301 as software. The processing by the manuscript submission system application 301 is realized by the CPU 201 executing a program that has been stored in the ROM 202 or the like.

The manuscript submission system application 301 includes a manuscript submission service section 311 and a print setting generating section 312.

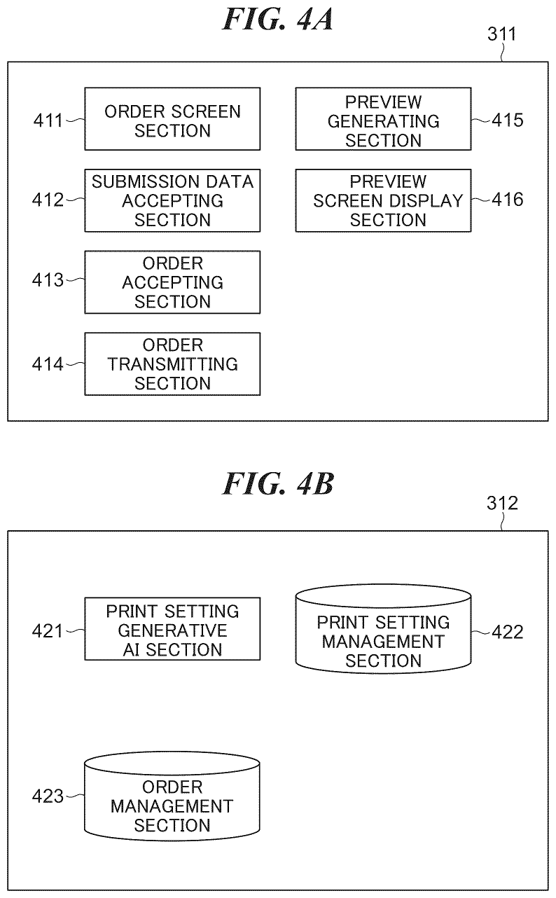

FIG. 4A is a block diagram that illustrates an example of a configuration of the manuscript submission service section 311 shown in FIG. 3, and FIG. 4B is a block diagram that illustrates an example of a configuration of the print setting generating section 312 shown in FIG. 3. First, the configuration of the manuscript submission service section 311 will be described with reference to FIG. 4A.

As shown in FIG. 4A, the manuscript submission service section 311 includes an order screen section 411, a submission data accepting section 412, an order accepting section 413, an order transmitting section 414, a preview generating section 415, and a preview screen display section 416.

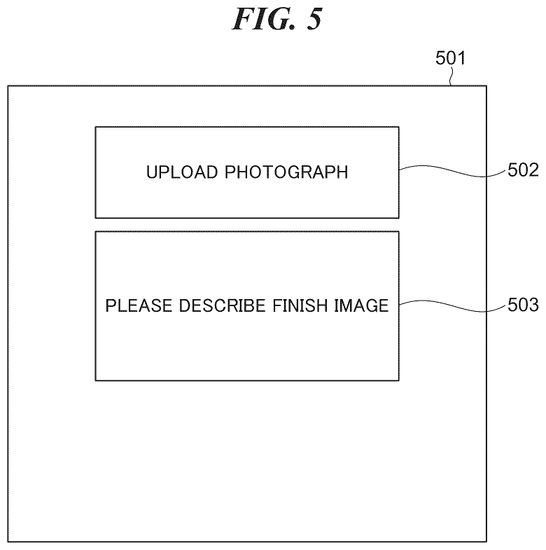

The order screen section 411 accepts the construction of a graphical user interface (a GUI) and various kinds of input operations from the user, and issues instructions to execute the corresponding processes. For example, the order screen section 411 generates an order screen 501 shown in FIG. 5, which will be described below. The submission data accepting section 412 accepts content data of a job used at the time of submission. The order accepting section 413 accepts order information required for generating a print setting. In the present embodiment, the order accepting section 413 accepts, as the order information, for example, a string of characters (a character string) that expresses, in natural language, a finish image (a finish impression) of a final product.

The order transmitting section 414 outputs the order information to a print setting generative AI section 421 (described below) that is included in the print setting generating section 312.

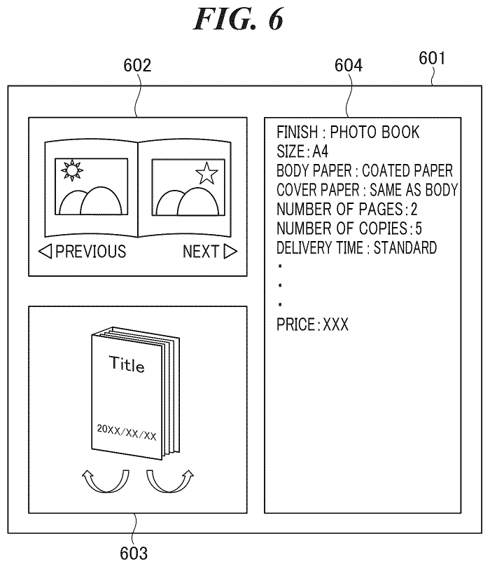

The preview generating section 415 generates a preview screen by using a print setting at the time of submission generated by the print setting generating section 312, and submission data. The preview screen display section 416 performs the display control of the preview screen that has been generated by the preview generating section 415. It should be noted that the configuration of the preview screen will be described below with reference to FIG. 6.

Next, the configuration of the print setting generating section 312 will be described with reference to FIG. 4B.

As shown in FIG. 4B, the print setting generating section 312 includes the print setting generative AI section 421, a print setting management section 422, and an order management section 423.

The print setting generative AI section 421 generates a prompt for generating a print setting based on the order information that has been received from the order transmitting section 414, and inputs the generated prompt into the large language model 102.

The print setting management section 422 manages a print setting required for manuscript submission. The print setting required for manuscript submission is a print setting that has been generated by the large language model 102 by using the prompt that has been transmitted from the print setting generative AI section 421 as input.

The order management section 423 manages information that is capable of being provided by the printing service. When inputting a prompt into the large language model 102, it is necessary to, as a precondition, provide the information that is capable of being provided by the printing service. The information that is capable of being provided by the printing service is assumed to include, but is not limited to, the size and type of printing paper, how to fold, the format and price of a product (the final product), and the like.

FIG. 5 is a diagram that illustrates an example of the order screen 501 generated by the order screen section 411 shown in FIG. 4A. The order screen 501 is displayed on a display that is included in the client PC 100 that has accessed the server PC 101. The order screen 501 is configured to include a data setting field 502 and an order information inputting field 503.

The data setting field 502 is a user interface component (a UI component) for realizing the function of the submission data accepting section 412, and is used when adding the content data of the job used at the time of submission, such as image data or the like. Examples of the method for uploading data include a method of designating a file stored in an arbitrary storage location by using a pointing device or the like that is included in the client PC 100, and a method of designating an arbitrary file by drag and drop, or the like.

The order information inputting field 503 is a UI component for realizing the function of the order accepting section 413. Order information for generating a print setting is inputted into the order information inputting field 503. Into the order information inputting field 503, as the order information, a character string that expresses, in natural language, a finish image (a finish impression) of the product, such as “Please make five copies of a photo book at a low price”, is inputted.

FIG. 6 is a diagram that illustrates an example of a preview screen 601 constructed by the preview screen display section 416 shown in FIG. 4A. Like the order screen 501, the preview screen 601 is also displayed on the display that is included in the client PC 100 that has accessed the server PC 101. The preview screen 601 is configured to include a double-page spread preview display section 602, an entire preview display section 603, and a print setting display section 604.

The double-page spread preview display section 602 displays an image, which shows a double-page spread state, as a preview for confirming an image (an impression) of a product that will be generated based on information that has been inputted on the order screen 501.

The entire preview display section 603 displays an image, which shows the appearance of the product, as a preview for confirming the image (the impression) of the product that will be generated based on the information that has been inputted on the order screen 501. This preview is, for example, a three dimensional display preview (a 3D display preview). It should be noted that the display method of the preview is not limited to the above-described methods, as long as it allows the user to confirm the image (the impression) of the product that will be generated based on the information that has been inputted on the order screen 501.

The print setting display section 604 displays a print setting, which is generated by inputting, into the large language model 102, a prompt based on the information that has been inputted on the order screen 501. It should be noted that in FIG. 6, this print setting is displayed in list format on the print setting display section 604, but this print setting may be displayed in another format as long as the another format allows the user to confirm this print setting. It should be noted that the preview screen 601 is not limited to have the configuration shown in FIG. 6, and may include other information. Furthermore, in the present embodiment, a configuration in which the preview-related processing is performed by the manuscript submission service section 311 will be described, but a configuration in which a preview screen is generated by using an LLM may also be used.

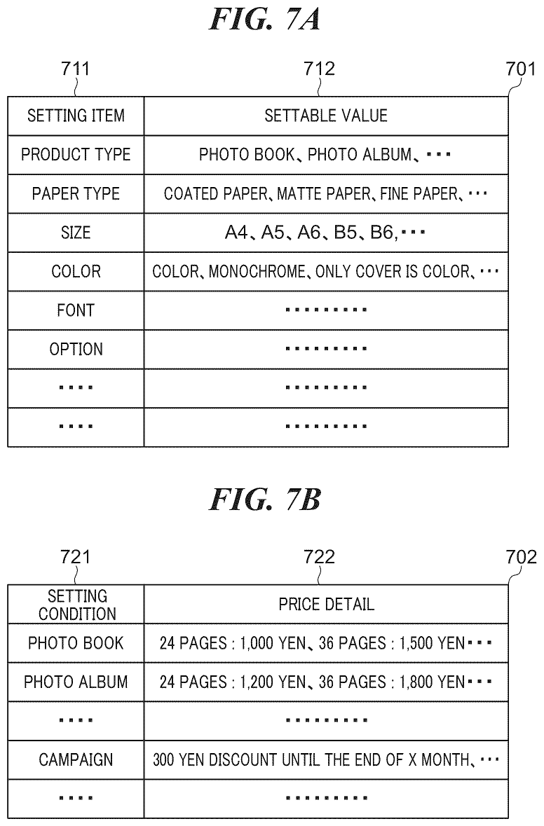

FIG. 7A and FIG. 7B are diagrams that illustrate examples of databases managed by the order management section 423 shown in FIG. 4B. The order management section 423 manages a capability value management database 701 shown in FIG. 7A and a price management database 702 shown in FIG. 7B as databases for managing service contents provided by the manuscript submission system 10.

The capability value management database 701 is a database that manages settings that are capable of being provided by the printing service of the manuscript submission system 10, and includes setting items 711 and settable values 712. The setting items 711 are items that are capable of being provided by the printing service, such as “product type”, “paper type”, “size”, “color”, “font”, “option”, and the like. The settable values 712 are specific values for each item in the setting items 711, such as “photo book”, “photo album”, and the like.

The price management database 702 is a database that manages the price corresponding to each setting, and includes setting conditions 721 and price details 722. The set conditions 721 are setting value conditions that determine the price. The price details 722 are prices for each condition in the set conditions 721.

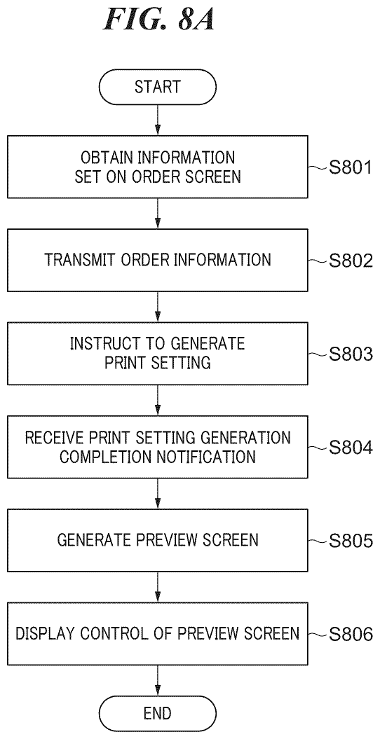

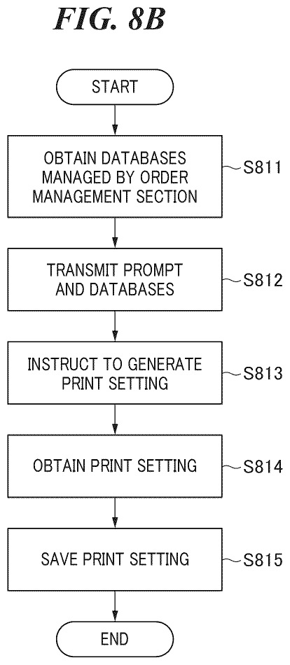

FIG. 8A and FIG. 8B are flowcharts that illustrate the procedure of a print setting save processing executed by the server PC 101 shown in FIG. 1. The print setting save processing is realized by the CPU 201 executing a program of the manuscript submission system application 301 that has been loaded from the HDD 204 into the RAM 203. The print setting save processing is started, for example, when the client PC 100 accesses the server PC 101. FIG. 8A illustrates the procedure of the processing performed by the manuscript submission service section 311 of the manuscript submission system application 301, and FIG. 8B illustrates the procedure of the processing performed by the print setting generating section 312 of the manuscript submission system application 301.

First, the processing performed by the manuscript submission service section 311 will be described. When the client PC 100 accesses the server PC 101, the order screen 501 is displayed on the display that is included in the client PC 100. When the user performs setting of each item on the order screen 501 and selects a determination button (not shown), information that has been set on the order screen 501 is transmitted from the client PC 100 to the server PC 101. As shown in FIG. 8A, the submission data accepting section 412 of the manuscript submission service section 311 obtains the information that has been set on the order screen 501 (S801). The information that has been set on the order screen 501 includes image file(s) and/or PDF file(s) that have been set by the data setting field 502 and the order information that has been inputted by the order information inputting field 503. It should be noted that in the present embodiment, as an example, it is assumed that 24 pieces of image data have been set by the data setting field 502, and the order information such as “Please make five copies of a photo book at a low price” has been inputted by the order information inputting field 503.

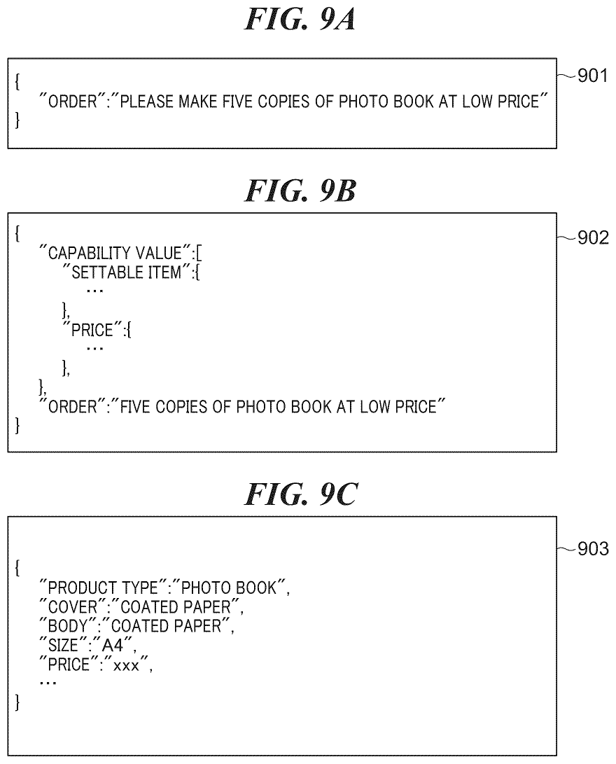

Next, in S802, the order transmitting section 414 of the manuscript submission service section 311 transmits the above order information to the print setting generating section 312. Specifically, the order transmitting section 414 transmits, to the print setting generating section 312, data 901 shown in FIG. 9A, which includes the order information such as “Please make five copies of a photo book at a low price”.

Next, in S803, the manuscript submission service section 311 instructs the print setting generating section 312 to generate a print setting. Upon receiving this instruction, the print setting generating section 312 starts the processing of FIG. 8B, inputs a prompt, which has been generated based on the order information transmitted in S802, into the large language model 102, and obtains a print setting, which has been generated based on this prompt, from the large language model 102.

Next, in S804, the manuscript submission service section 311 receives a print setting generation completion notification from the print setting generating section 312.

Next, in S805, the preview generating section 415 of the manuscript submission service section 311 generates a preview screen of a product that will be generated based on the information that has been set on the order screen 501. For example, the preview generating section 415 obtains the print setting that has been generated by the large language model 102 through the processing of FIG. 8B performed by the print setting generating section 312, which will be described below. For example, in the case where the obtained print setting is contents indicated by data 903 shown in FIG. 9C, it is identified from these contents that the order is for a photo book. The preview generating section 415 obtains rough shape information of the photo book from pre-retained management information (not shown), and based on the obtained rough shape information, generates an image to be displayed on the entire preview display section 603, specifically, an image for confirming the appearance of the product. In addition, the preview generating section 415 obtains layout information for the image data that has been inputted into the data setting field 502, and based on the image data and the layout information, generates an image to be displayed on the double-page spread preview display section 602, specifically, an image for confirming the double-page spread state. It should be noted that the layout information is information that indicates which image data is to be laid out on which page. The layout information may be configured to allocate the inputted image data from the first page, for example, in accordance with the order in which they have been inputted into the data setting field 502. In addition, the layout information may be generated based on the layout information of each piece of image data that has been inputted as the order information into the order information inputting field 503 or information on how many pieces of image data are to be laid out on one page.

Next, in S806, the preview screen display section 416 of the manuscript submission service section 311 performs the display control of the preview screen that has been generated by the preview generating section 415. In S806, for example, data for displaying this preview screen is transmitted from the server PC 101 to the client PC 100. The preview screen 601 shown in FIG. 6 is displayed on the display that is included in the client PC 100 that has received this data. After that, the processing of FIG. 8A ends.

Next, the processing performed by the print setting generating section 312 will be described with reference to FIG. 8B. The processing performed by the print setting generating section 312 is started when the print setting generating section 312 receives, from the manuscript submission service section 311 in S803, the instruction to generate a print setting.

As shown in FIG. 8B, the print setting generative AI section 421 of the print setting generating section 312 obtains the databases managed by the order management section 423 (S811). Specifically, the print setting generative AI section 421 obtains the capability value management database 701 and the price management database 702.

Next, the print setting generative AI section 421 generates a prompt based on the order information that has been transmitted from the manuscript submission service section 311 in S802. The print setting generative AI section 421 transmits, to the large language model 102, the generated prompt, and the databases that have been obtained in S811 (S812). Specifically, the print setting generative AI section 421 transmits, to the large language model 102, data 902 shown in FIG. 9B, which includes the generated prompt and the databases that have been obtained in S811.

Next, in S813, the print setting generating section 312 instructs the large language model 102 to generate a print setting. In accordance with this instruction, the large language model 102 uses, as input, the prompt and the databases that have been transmitted in S812 to generate a print setting that is an appropriate response to this prompt.

Next, in S814, the print setting generative AI section 421 of the print setting generating section 312 obtains the print setting from the large language model 102. Specifically, the print setting generative AI section 421 obtains, from the large language model 102, the data 903 shown in FIG. 9C, which includes the print setting that has been generated by the large language model 102.

Next, in S815, the print setting generative AI section 421 saves the obtained print setting in the print setting management section 422. In addition, the print setting generating section 312 transmits the print setting generation completion notification to the manuscript submission service section 311. After that, the processing of FIG. 8B ends.

According to the above-described embodiment, order information expressing a finish of printing in natural language is accepted from the user, and a prompt based on this order information is inputted into the large language model 102. Information based on a print setting that has been obtained from the large language model 102 by using this prompt as input is outputted. In other words, the user only needs to input the order information expressing the finish of printing in natural language, thereby obtaining a print setting with which a final product with this finish. As a result, it is possible to easily perform a print setting.

In addition, in the above-described embodiment, the images based on the print setting obtained from the large language model and the image data inputted into the data setting field 502 are displayed on the double-page spread preview display section 602 and the entire preview display section 603. As a result, it is possible for the user to, before requesting printing at a printing factory, confirm whether or not a final product with an intended finish is capable of being obtained with the print setting obtained from the large language model.

In addition, in the above-described embodiment, the databases for managing the service contents capable of being provided by the manuscript submission system 10 (the databases that have been obtained in S811) are inputted into the large language model 102 along with the prompt. As a result, it is possible to include appropriate items in the print setting from among the items that are capable of being provided by the manuscript submission system 10.

It should be noted that in the above-described embodiment, although the configuration, in which the server PC 101 performs the generation of the preview screen in S805, has been described, the present disclosure is not limited to this configuration. For example, the generation of the preview screen in S805 may be performed by a large language model specialized for image generation.

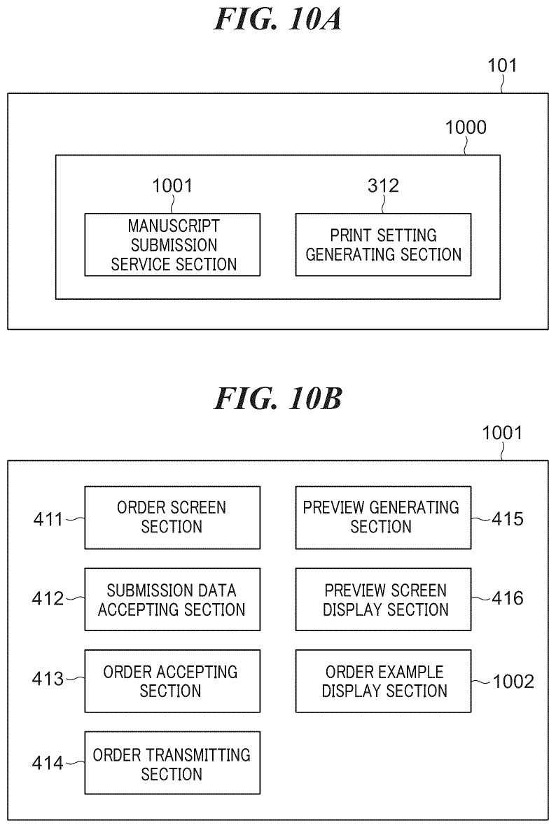

In addition, in the present embodiment, the server PC 101 may include a manuscript submission system application 1000 shown in FIG. 10A, which is capable of displaying an input example of order information inputted by the user in natural language.

The manuscript submission system application 1000 includes a manuscript submission service section 1001 in addition to the print setting generating section 312 that has been described above. It should be noted that the processing by the manuscript submission system application 1000 is realized by the CPU 201 executing a program that has been stored in the ROM 202 or the like.

As shown in FIG. 10B, the manuscript submission service section 1001 includes an order example display section 1002 in addition to the order screen section 411, the submission data accepting section 412, the order accepting section 413, the order transmitting section 414, the preview generating section 415, and the preview screen display section 416 that have been described above. The order example display section 1002 performs control to display the input example of the order information inputted by the user in natural language at the time of submission.

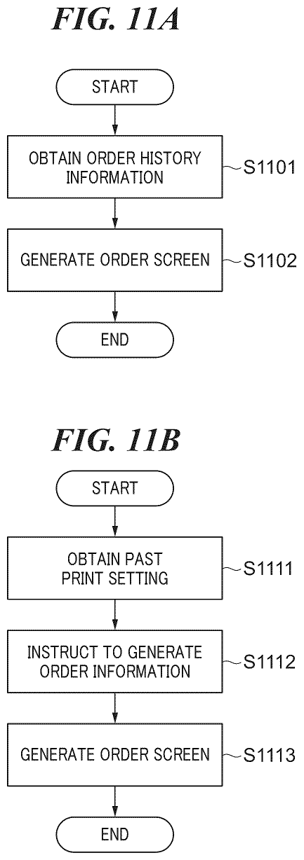

FIG. 11A is a flowchart that illustrates one procedure of an input example display control processing by the order example display section 1002 shown in FIG. 10B. The input example display control processing is realized by the CPU 201 executing a program of the manuscript submission system application 1000 that has been loaded from the HDD 204 into the RAM 203. The input example display control processing is started when the manuscript submission system application 1000 is started, and is completed before the print setting save processing described above is started.

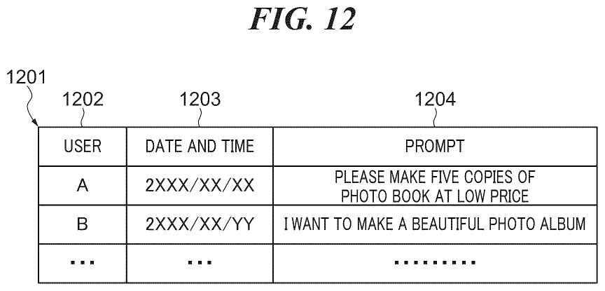

As shown in FIG. 11A, the order accepting section 413 of the manuscript submission system application 1000 obtains order history information from the order management section 423 (S1101). The order history information is order information that has been inputted in the past (order information that has previously been inputted). In the present embodiment, the order management section 423 manages the order history information by an order history management database 1201 shown in FIG. 12. The order history management database 1201 includes a user 1202, a date and time 1203, and a prompt 1204.

The user 1202 is the name of a user who has placed an order by using the manuscript submission system application 1000. The date and time 1203 is information which indicates a date and time when an order has been placed by using the manuscript submission system application 1000. The prompt 1204 is order information that has been inputted when an order has been placed by using the manuscript submission system application 1000. It should be noted that in the present embodiment, when the manuscript submission system application 1000 is started, the manuscript submission system application 1000 obtains, from the client PC 100, information about a user who operates the client PC 100 that has accessed the server PC 101. In S1101, the order accepting section 413 obtains, as the order history information, information corresponding to the user who operates the client PC 100 that has accessed the server PC 101 among information that has been recorded in the prompt 1204 of the order history management database 1201.

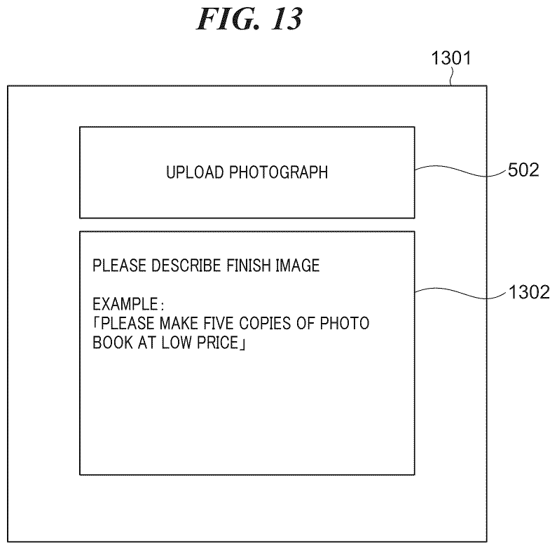

Next, in S1102, the order screen section 411 and the order example display section 1002 generate an order screen 1301 shown in FIG. 13 based on the obtained order history information. The order screen 1301 has a configuration similar to the configuration of the order screen 501 described above, and is configured to include the data setting field 502 described above and an order information inputting field 1302. The order information inputting field 1302 is an inputting field for inputting order information for generating a print setting. On the order information inputting field 1302, the information that has been obtained as the order history information in S1101, that is, order history information corresponding to the user who operates the client PC 100, is displayed as the input example of the order information. After that, the processing of FIG. 11A ends. The generated order screen 1301 is displayed on the display that is included in the client PC 100 that has accessed the server PC 101. As a result, the user is able to understand what information should be inputted as the order information on the order screen 1301.

Here, in the case where the user who operates the client PC 100 that has accessed the server PC 101 has never placed an order by using the manuscript submission system application 1000, it is not possible to display the input example of the order information by using the above-described method.

Therefore, order history information corresponding to a user other than the user who operates the client PC 100 may be displayed as the input example of the order information.

In addition, the input example of the order information may be generated by using a print setting that has been used at the time of past submission.

FIG. 11B is a flowchart that illustrates another procedure of the input example display control processing by the order example display section 1002 shown in FIG. 10B. Similar to the input example display control processing of FIG. 11A that has been described above, the input example display control processing of FIG. 11B is also realized by the CPU 201 executing a program of the manuscript submission system application 1000 that has been loaded from the HDD 204 into the RAM 203. Similar to the input example display control processing of FIG. 11A that has been described above, the input example display control processing of FIG. 11B is also started when the manuscript submission system application 1000 is started, and is also completed before the print setting save processing described above is started.

As shown in FIG. 11B, first, the order accepting section 413 obtains, from the print setting management section 422, a print setting that has been used at the time of past submission (S1111). Here, in the present embodiment, when the server PC 101 has saved the print setting that has been obtained from the large language model 102 in S815, the print setting management section 422 registers, in a database (not shown), the print setting that has been obtained from the large language model 102 in S815. In S1111, the order accepting section 413 obtains the print setting from this database (not shown). For example, the order accepting section 413 obtains the latest print setting from this database. It should be noted that here, as an example, a configuration for obtaining one print setting from this database will be described, but the number of print settings to be obtained is not limited to one, and the number of print settings that are capable of being displayed as input examples on the order information inputting field 1302, for example, about three print settings may be obtained.

Next, in S1112, the order accepting section 413 instructs the large language model 102 to input the print setting obtained in S1111 and generate order information.

Next, in S1113, the order screen section 411 and the order example display section 1002 generate the order screen 1301 shown in FIG. 13 based on order information that has been outputted from the large language model 102. After that, the processing of FIG. 11B ends.

With such a configuration, even in the case where a user has never placed an order by using the manuscript submission system application 1000, the user is able to understand what information should be inputted as the order information on the order screen 1301.

It should be noted that a configuration may be adopted in which the order screen 1301 further includes a support button (not shown), and when this support button has been pressed by the user, the input example of the order information is displayed on the order information inputting field 1302.

In addition, in the present embodiment, in the case where the user has issued a correction instruction for the print setting outputted from the large language model 102 (an instruction to correct the print setting outputted from the large language model 102), the large language model 102 may be caused to regenerate a print setting in accordance with this correction instruction, and the large language model 102 may be caused to learn correction content (the large language model 102 may be trained with the correction content).

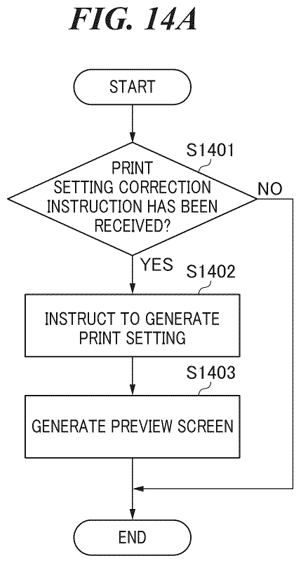

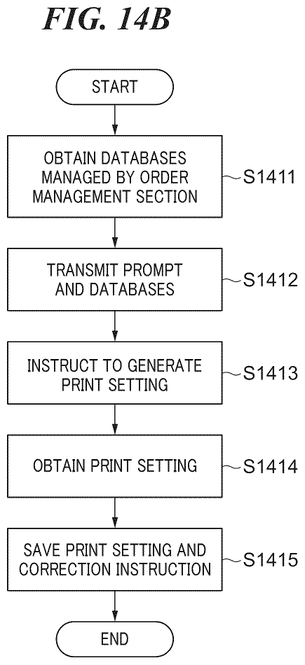

FIG. 14A and FIG. 14B are flowcharts that illustrate the procedure of a print setting correction processing executed by the server PC 101 shown in FIG. 1. The print setting correction processing is realized by the CPU 201 executing the program of the manuscript submission system application 301 that has been loaded from the HDD 204 into the RAM 203. The print setting correction processing is executed when the print setting save processing described above is completed and the preview screen 601 is displayed on the display that is included in the client PC 100. It should be noted that FIG. 14A illustrates the procedure of the processing performed by the manuscript submission service section 311 of the manuscript submission system application 301, and FIG. 14B illustrates the procedure of the processing performed by the print setting generating section 312 of the manuscript submission system application 301.

First, the processing performed by the manuscript submission service section 311 will be described. Through the process of S806 described above, the user confirms on the preview screen 601, which has been displayed on the display that is included in the client PC 100, whether or not the finish (the finished image) is as intended. In the case where the result of confirmation is that the finish is not as intended by the user, the user instructs the correction of the print setting that has been outputted from the large language model 102. The user instructs the correction by using a character string in natural language, such as “change the cover paper”. It should be noted that in the present embodiment, the user instructs the correction by, for example, inputting the correction content in a chatbot format, inputting the correction content into an inputting field (not shown) provided on the preview screen 601, or inputting the correction content into a pop-up displayed inputting field (not shown). The client PC 100 transmits, to the server PC 101, a print setting correction instruction that includes the inputted instruction content.

As shown in FIG. 14A, the order accepting section 413 determines whether or not a print setting correction instruction has been received (S1401). In the case of being determined that a print setting correction instruction has not been received, the processing of FIG. 14A ends. On the other hand, in the case of being determined that a print setting correction instruction has been received, the processing of FIG. 14A proceeds to S1402.

In S1402, the manuscript submission service section 311 instructs the print setting generating section 312 to generate a print setting based on the received print setting correction instruction. In accordance with this instruction, the print setting generating section 312 starts the processing of FIG. 14B, causes the large language model 102 to generate a print setting based on the print setting correction instruction, and transmits, to the manuscript submission service section 311, the print setting that has been generated by the large language model 102.

The preview generating section 415 of the manuscript submission service section 311 generates a preview screen based on the print setting that has been received from the print setting generating section 312. Next, the preview screen display section 416 of the manuscript submission service section 311 performs the display control of the preview screen that has been generated by the preview generating section 415 (S1403). In S1403, for example, data for displaying this preview screen is transmitted from the server PC 101 to the client PC 100. As a result, a preview screen reflecting the print setting that has been generated based on the print setting correction instruction is displayed on the display that is included in the client PC 100. After that, the processing of FIG. 14A ends.

Next, the processing performed by the print setting generating section 312 will be described. As described above, the processing performed by the print setting generating section 312 is executed when the print setting generating section 312 receives the instruction to generate a print setting that has been issued by the manuscript submission service section 311 in S1402.

As shown in FIG. 14B, first, similar to S811 described above, the print setting generative AI section 421 of the print setting generating section 312 obtains the databases managed by the order management section 423 (S1411). Specifically, the print setting generative AI section 421 obtains the capability value management database 701 and the price management database 702.

Next, the print setting generative AI section 421 generates a prompt based on the above instruction that has been received from the manuscript submission service section 311. Similar to S812 described above, the print setting generative AI section 421 transmits, to the large language model 102, the generated prompt, and the databases that have been obtained in S1411 (S1412).

Next, in S1413, similar to S813 described above, the print setting generating section 312 instructs the large language model 102 to generate a print setting. In accordance with this instruction, the large language model 102 uses, as input, the prompt and the databases that have been transmitted in S1412 to generate a print setting that is an appropriate response to this prompt.

Next, in S1414, the print setting generative AI section 421 of the print setting generating section 312 obtains the print setting from the large language model 102.

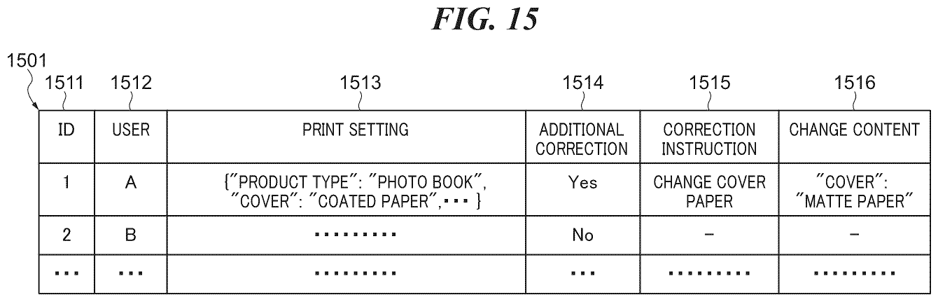

Next, in S1415, the print setting generative AI section 421 saves the generated print setting and a correction instruction corresponding to the above instruction that has been received from the manuscript submission service section 311. The print setting and the correction instruction that have been saved are recorded in a print setting management table 1501 shown in FIG. 15, which is managed by the print setting management section 422.

FIG. 15 is a diagram that illustrates an example of the print setting management table 1501 managed by the print setting management section 422 shown in FIG. 4B. The print setting management table 1501 is updated, for example, when the process of S815 is completed in the print setting save processing shown in FIG. 8A and FIG. 8B that has been described above, or when the process of S1415 is completed in the print setting correction processing shown in FIG. 14A and FIG. 14B that has been described above.

As shown in FIG. 15, the print setting management table 1501 includes an ID 1511, a user 1512, a print setting 1513, an additional correction 1514, a correction instruction 1515, and a change content 1516.

In the ID 1511, an identifier for uniquely identifying each order that has been placed by using the manuscript submission system application 1000 is recorded. In the user 1512, the name of a user who has placed an order by using the manuscript submission system application 1000 is recorded.

In the print setting 1513, the print setting, which has been generated by the large language model 102 in the print setting save processing shown in FIG. 8A and FIG. 8B that has been described above, is recorded.

In the additional correction 1514, information, which indicates whether or not correction has been performed based on a correction instruction from the user, is recorded. In the case where “Yes”, which indicates that correction has been performed, is recorded in the additional correction 1514, various information is recorded in the correction instruction 1515 and the change content 1516, respectively. In the correction instruction 1515, the correction instruction that has been saved in S1415 is recorded. In the change content 1516, difference information between a print setting after correction, which has been generated by the large language model 102 based on the correction instruction that has been saved in S1415, and a print setting before correction is recorded. It should be noted that in the present embodiment, as an example, a configuration will be described in which the difference information between the print setting after correction and the print setting before correction is recorded in the change content 1516, but information to be recorded in the change content 1516 is not limited to such difference information. For example, the print setting after correction may be recorded as it is in the change content 1516. In addition, a configuration may be adopted in which the content of the correction instruction 1515 and the content of the change content 1516 are recorded at a timing when the manuscript submission becomes definite.

The information updated in the print setting management table 1501 is transmitted to the large language model 102, and the large language model 102 is caused to perform additional learning by using the received information (the large language model 102 is additional-trained by using the received information). It should be noted that in a print setting save processing using the large language model 102 after additional training (after additional learning), the procedure of the processing performed by the manuscript submission service section 311 is the same as the procedure shown in the flowchart of FIG. 8A described above, but the procedure of the processing performed by the print setting generating section 312 is different from the procedure shown in the flowchart of FIG. 8B described above. Therefore, the following will describe the differences from the flowchart of FIG. 8B described above.

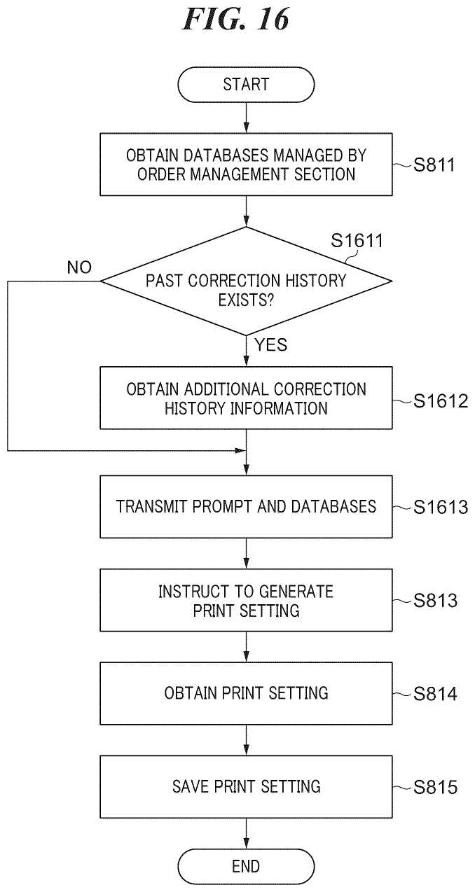

FIG. 16 is a flowchart that illustrates the procedure of the processing performed by the print setting generating section 312 in the print setting save processing using the large language model 102 after additional training. Similar to the processing performed by the print setting generating section 312, which is shown in FIG. 8B and has been described above, the processing performed by the print setting generating section 312, which is shown in FIG. 16, is also started when the print setting generating section 312 receives, from the manuscript submission service section 311 in S803, the instruction to generate a print setting.

As shown in FIG. 16, first, the process of S811 described above is performed. Next, in S1611, the print setting generative AI section 421 determines, based on the print setting management table 1501, whether or not there is a past correction history by a user who has set the information that has been obtained in S801. In the case of being determined that there is no past correction history by the user who has set the information that has been obtained in S801, the print setting generative AI section 421 generates a prompt based on the order information that has been transmitted from the manuscript submission service section 311 in S802. Next, the processing of FIG. 16 proceeds to S1613, which will be described below. On the other hand, in the case of being determined that there is a past correction history by the user who has set the information that has been obtained in S801, the processing of FIG. 16 proceeds to S1612.

In S1612, the print setting generative AI section 421 obtains, from the print setting management table 1501, information about the past correction history by the user who has set the information that has been obtained in S801 (correction history information by the user who has set the information that has been obtained in S801).

Next, the print setting generative AI section 421 generates a prompt based on the order information that has been transmitted from the manuscript submission service section 311 in S802. The print setting generative AI section 421 transmits, to the large language model 102, the generated prompt, and the databases that have been obtained in S811 (S1613). It should be noted that in the case where the correction history information by the user who has set the information that has been obtained in S801 has been obtained in S1612, this correction history information is also transmitted to the large language model 102. Next, the above-described processes of S813 to S815 are performed, and the processing of FIG. 16 ends.

In this way, in the above-described embodiment, when a correction instruction for the print setting obtained from the large language model 102 has been received from the user, the large language model 102 is caused to learn correction content based on the correction instruction (the large language model 102 is trained with the correction content based on the correction instruction). As a result, it is possible to output a print setting that better reflects the user's preferences and thoughts.

It should be noted that a configuration has been described in which the correction history information of the user is used in the print setting save processing of FIG. 16 that has been described above, but the present disclosure is not limited to this configuration. For example, all of the order history information of the user may be used.

In addition, in the present embodiment, when a correction instruction has been issued by the user, print setting change content based on this correction instruction (changes to the print setting based on this correction instruction) may be presented. In such a configuration, regarding the print setting correction processing that has been described above, the procedure thereof is partially different. Specifically, the procedure of the processing performed by the manuscript submission service section 311 is different from the procedure shown in the flowchart of FIG. 14A described above. In the following, the differences from the flowchart of FIG. 14A described above will be particularly described.

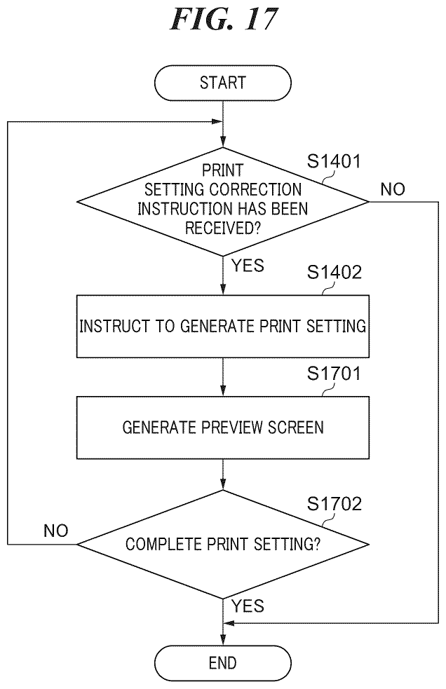

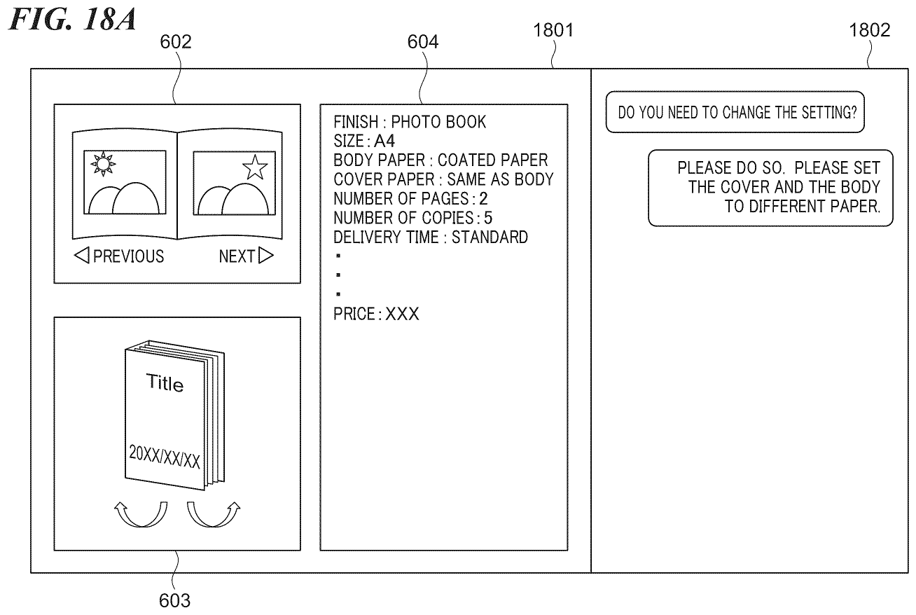

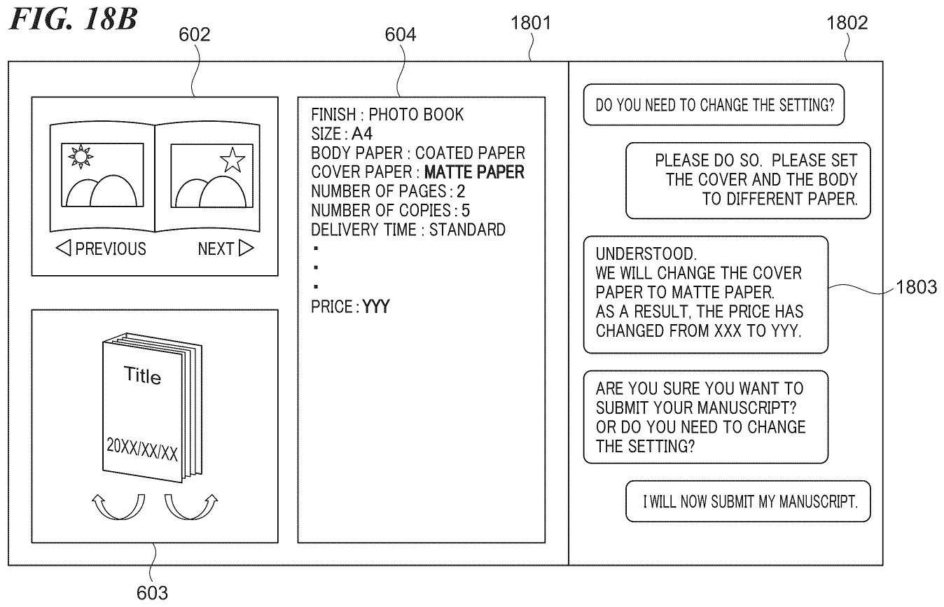

FIG. 17 is a flowchart that illustrates the procedure of the processing performed by the manuscript submission service section 311 in the print setting correction processing executed by the server PC 101 shown in FIG. 1. The processing of FIG. 17 is realized by the CPU 201 executing the program of the manuscript submission system application 301 that has been loaded from the HDD 204 into the RAM 203. It should be noted that the processing of FIG. 17 is executed when the print setting save processing described above is completed and a preview screen 1801 shown in FIG. 18A is displayed on the display that is included in the client PC 100. The preview screen 1801 includes the double-page spread preview display section 602, the entire preview display section 603, and the print setting display section 604 that have been described above, as well as a correction instruction inputting section 1802. It is possible to input a correction instruction for the print setting in a chatbot format into the correction instruction inputting section 1802. It should be noted that the correction instruction inputting section 1802 is not limited to a chatbot type UI component.

As shown in FIG. 17, first, the processes of S1401 and S1402 that have been described above are performed. Next, the preview generating section 415 of the manuscript submission service section 311 generates a preview screen based on the print setting that has been received from the print setting generating section 312 (S1701). Next, the preview screen display section 416 of the manuscript submission service section 311 performs the display control of the preview screen that has been generated by the preview generating section 415. In the display control, for example, data for displaying this preview screen is transmitted from the server PC 101 to the client PC 100. As a result, a preview screen 1801 shown in FIG. 18B, which reflects the print setting that has been generated based on the print setting correction instruction, is displayed on the display that is included in the client PC 100. On the preview screen 1801 shown in FIG. 18B, a message 1803, which indicates the print setting change content based on the correction instruction from the user, is displayed.

Next, in S1702, the manuscript submission service section 311 determines whether or not the print setting is to be completed. For example, in the case of having been detected that the user has inputted a manuscript submission instruction such as “I will now submit my manuscript” into the correction instruction inputting section 1802, it is determined that the print setting is to be completed. On the other hand, in the case of having not been detected that the user has inputted a manuscript submission instruction into the correction instruction inputting section 1802, it is determined that the print setting is not to be completed.

In the case of being determined that the print setting is not to be completed, the processing of FIG. 17 returns to S1401. On the other hand, in the case of being determined that the print setting is to be completed, the processing of FIG. 17 ends.

In this way, in the processing of FIG. 17 described above, when a correction instruction has been issued by the user, print setting change content based on this correction instruction (changes to the print setting based on this correction instruction) is presented. As a result, the user is able to confirm how the print setting will be changed based on the correction instructions before submitting his/her manuscript.

It should be noted that in the processing of FIG. 14A, FIG. 14B, and FIG. 17 that have been described above, a configuration has been described in which the large language model 102 is caused to regenerate a print setting based on the print setting correction instruction, but the present disclosure is not limited to this configuration. For example, a configuration may be adopted in which the server PC 101 directly changes the corresponding item of the print setting based on the print setting correction instruction.

In addition, in the present embodiment, the order screen generated by the order screen section 411 may include a parameter bar, which is a UI component for realizing the function of the order accepting section 413.

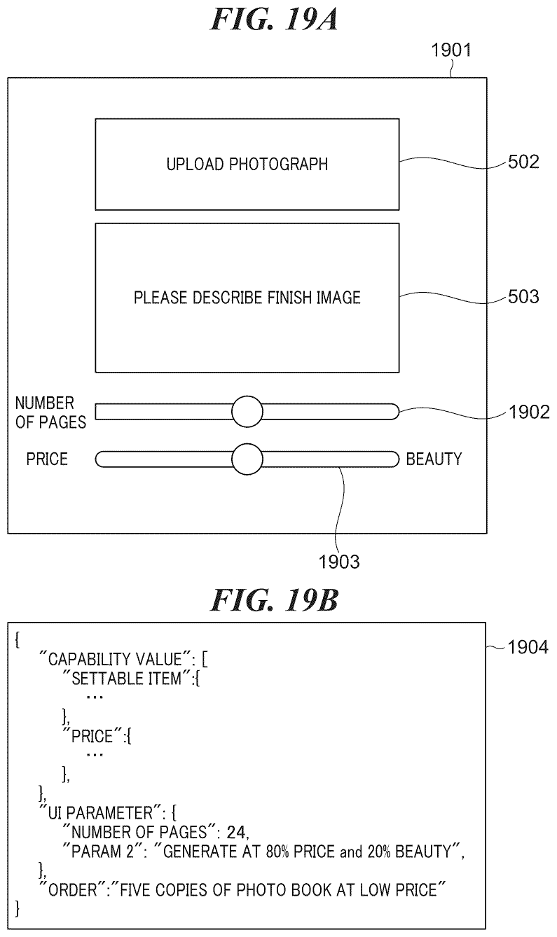

FIG. 19A and FIG. 19B are diagrams that illustrate an example of an order screen 1901 generated by the order screen section 411 shown in FIG. 4A. Like the order screen 501 that has been described above, the order screen 1901 is also displayed on the display that is included in the client PC 100 that has accessed the server PC 101. The order screen 1901 includes a parameter bar 1902 and a parameter bar 1903 in addition to the data setting field 502 and the order information inputting field 503 that have been described above. The parameter bar 1902 and the parameter bar 1903 are UI components for setting parameters that assist the order information to be inputted into the order information inputting field 503. The parameter bar 1902 is used to designate the number of pages of the product. The parameter bar 1903 is used to designate a ratio that indicates which of two contradictory concepts, price and good appearance of the product (beauty of the product), is to be given priority. It should be noted that the configuration of the order screen 1901 is not limited to this configuration. The order screen 1901 may further include other parameter bars, for example, a parameter bar for designating the number of photos that are capable of being laid out on one page.

In addition, the order screen 1901 may include a UI component for switching between displaying and hiding the parameter bar 1902 and the parameter bar 1903. For example, in a configuration in which a check box is provided as such a UI component, in the case where this check box has been selected, the parameter bar 1902 and the parameter bar 1903 are displayed on the order screen 1901. On the other hand, in the case where this check box has not been selected, the parameter bar 1902 and the parameter bar 1903 are not displayed on the order screen 1901. By providing such a UI component, it is possible to allow only users who need the parameter bar 1902 and the parameter bar 1903 to use these UI components.

In the case where the order screen 1901 has been displayed on the display that is included in the client PC 100, the print setting save processing shown in FIG. 8A and FIG. 8B that has been described above is executed as follows. For example, in S801, the submission data accepting section 412 obtains image file(s) and/or PDF file(s) that have been set by the data setting field 502 and the order information that has been inputted by the order information inputting field 503, as well as setting values that have been set by the parameter bar 1902 and the parameter bar 1903, respectively. In addition, in S802, the order transmitting section 414 transmits, to the print setting generating section 312, the above order information, and the setting values that have been set by the parameter bar 1902 and the parameter bar 1903, respectively. The print setting generative AI section 421 of the print setting generating section 312 generates a prompt based on the received order information, and the setting values that have been set by the parameter bar 1902 and the parameter bar 1903, respectively. Next, in S812, the print setting generative AI section 421 transmits, to the large language model 102, data 1904 shown in FIG. 19B, which includes the generated prompt and the databases that have been obtained in S811. In addition to the contents of the data 902 described above, the data 1904 includes, as UI parameters, the setting values that have been set by the parameter bar 1902 and the parameter bar 1903, respectively. The large language model 102 uses, as input, the prompt and the databases that are included in the obtained data 1904 to generate a print setting. As a result, it is possible to generate a print setting that better reflects the user's intentions.

Here, as described above, in the case of using an order screen including the order information inputting field and the parameter bars, there may be cases where the order information that has been inputted into the order information inputting field and the parameters that have been set by the parameter bars are contradictory. For example, there is a case where the order information that has been inputted into the order information inputting field includes a keyword “low price”, while a parameter that prioritizes beauty over price is set by the parameter bar 1903. In such a case, there is a concern that it may not be possible to provide an appropriate print setting that reflects both the order information that has been inputted into the order information inputting field and the parameter that has been set by the parameter bar.

In order to deal with this issue, in the present embodiment, in the case where contradictory conditions have been inputted on the order screen, priority information indicating which of the conditions that have been inputted is to be given priority is further inputted into the large language model 102. In such a configuration, regarding the print setting save processing that has been described above, the procedure thereof is partially different. Specifically, the procedure of the processing performed by the print setting generating section 312 is different from the procedure shown in the flowchart of FIG. 8B described above. In the following, the differences from the flowchart of FIG. 8B described above will be particularly described.

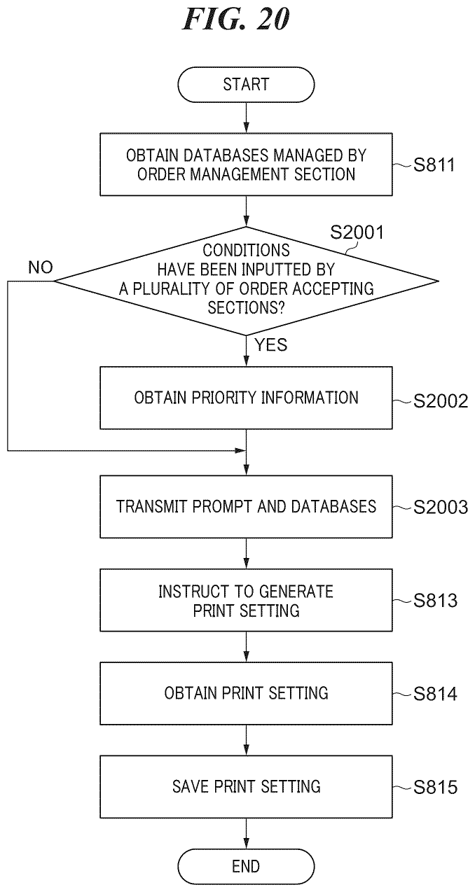

FIG. 20 is a flowchart that illustrates the procedure of the processing performed by the print setting generating section 312 in the print setting save processing executed by the server PC 101 shown in FIG. 1. Similar to the processing performed by the print setting generating section 312, which is shown in FIG. 8B and has been described above, the processing performed by the print setting generating section 312, which is shown in FIG. 20, is also started when the print setting generating section 312 receives, from the manuscript submission service section 311 in S803, the instruction to generate a print setting.

As shown in FIG. 20, first, the process of S811 described above is performed. Next, in S2001, the print setting generative AI section 421 determines whether or not conditions have been inputted by a plurality of order accepting sections. For example, in the case where a printing order has been placed on the order screen 1901 with the parameter bars 1902 and 1903 hidden or the order screen 501, only the order information inputting field 503 is used out of the order information inputting field 503 and the parameter bars 1902 and 1903 each functioning as the order accepting section 413. In such a case, it is determined in S2001 that conditions have not been inputted by a plurality of order accepting sections, and the print setting generative AI section 421 generates a prompt based on the order information that has been inputted into the order information inputting field 503. Next, the processing of FIG. 20 proceeds to S2003, which will be described below.

On the other hand, in the case where a printing order has been placed on the order screen 1901 with the parameter bars 1902 and 1903 displayed, all of the order information inputting field 503 and the parameter bars 1902 and 1903 each functioning as the order accepting section 413 are used. In such a case, it is determined in S2001 that conditions have been inputted by a plurality of order accepting sections, and the processing of FIG. 20 proceeds to S2002.

In S2002, the print setting generative AI section 421 obtains priority information that has been retained in advance in the RAM 202 or the like. The priority information is information indicating which of a plurality of conditions that have been inputted on the order screen is to be given priority. For example, the priority information is information indicating which of the order information that has been inputted into the order information inputting field 503 and the parameters that have been set by the parameter bars 1902 and 1903 is to be given priority.

Next, the print setting generative AI section 421 generates a prompt based on the order information that has been inputted into the order information inputting field 503, and the setting values that have been set by the parameter bar 1902 and the parameter bar 1903, respectively. The print setting generative AI section 421 transmits, to the large language model 102, the generated prompt, and the databases that have been obtained in S811 (S2003). It should be noted that in the case where the priority information has been obtained in S2002, furthermore in S2003, the print setting generative AI section 421 also transmits this priority information to the large language model 102. After that, the above-described processes of S813 to S815 are performed, and the processing of FIG. 20 ends. The large language model 102, into which the priority information has been inputted in addition to the prompt and the databases, generates one print setting, for example, by giving a first priority to the order information that has been inputted into the order information inputting field 503 and giving a second priority to the parameters that have been set by the parameter bars 1902 and 1903. In addition, the large language model 102 generates a first print setting based on the order information that has been inputted into the order information inputting field 503, and generates a second print setting based on the parameters that have been set by the parameter bars 1902 and 1903.

In this way, in the print setting save processing of FIG. 20 that has been described above, in the case where contradictory conditions have been inputted on the order screen, the priority information indicating which of the conditions that have been inputted is to be given priority is further inputted into the large language model 102. As a result, even in the case where contradictory conditions have been inputted in a printing order, it is possible to provide an appropriate print setting.

It should be noted that a configuration has been described in which the obtainment of the priority information is controlled based on whether or not conditions have been inputted by a plurality of order accepting sections in the print setting save processing of FIG. 20 that has been described above, but the present disclosure is not limited to this configuration. For example, a configuration may be adopted in which the order information that has been inputted into the order information inputting field 503 is analyzed, and the obtainment of the priority information is controlled based on whether or not this order information includes contradictory conditions. In such a configuration, for example, a plurality of keywords that are expected to be included in the order information are registered in the priority information, and the priority information includes information indicating the priorities of the plurality of keywords. The large language model 102, into which such priority information has been inputted, generates one print setting, for example, by giving a first priority to a first keyword in the order information that has been inputted into the order information inputting field 503 and giving a second priority to a second keyword in the order information that has been inputted into the order information inputting field 503. In addition, the large language model 102 generates a first print setting based on the first keyword in the order information that has been inputted into the order information inputting field 503, and generates a second print setting based on the second keyword in the order information that has been inputted into the order information inputting field 503. Even with such a configuration, in the case where contradictory conditions have been inputted in a printing order, it is possible to provide an appropriate print setting.

According to the present disclosure, it is possible to easily perform a print setting.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-166125, filed Sep. 25, 2024, which is hereby incorporated by reference herein in its entirety.

What is claimed is:

1. A manuscript submission system comprising:
at least one processor; and
a memory coupled to the processor storing instructions that, when executed by the processor, cause the processor to function as:
an accepting unit that accepts, from a user, order information expressing a finish of printing in natural language;
an inputting unit that inputs a prompt based on the order information into a large language model; and
an outputting unit that outputs information based on a print setting which has been obtained from the large language model using the prompt as an input.

2. The manuscript submission system according to claim 1, wherein
the inputting unit inputs, into the large language model, databases for managing service contents provided by the manuscript submission system along with the prompt.

3. The manuscript submission system according to claim 1, wherein
the accepting unit further accepts image data to be used for the printing, and
the outputting unit displays the print setting which has been obtained from the large language model, and an image based on the image data.

4. The manuscript submission system according to claim 1, wherein
the processor is caused to further function as an input example display control unit that performs control to display an input example of the order information, and
the input example display control unit displays, as the input example, order information that has previously been inputted by the user.

5. The manuscript submission system according to claim 1, wherein
the processor is caused to further function as an input example display control unit that performs control to display an input example of the order information, and
the input example display control unit displays, as the input example, order information that has been obtained by inputting, into the large language model, a print setting that has previously been generated by the large language model.

6. The manuscript submission system according to claim 1, wherein
the processor is caused to further function as an order screen display control unit that performs control to display an order screen for accepting the order information from the user, and
the order screen includes a first UI component for inputting the order information and a second UI component for setting a parameter that assists the order information.

7. The manuscript submission system according to claim 6, wherein
the order screen further includes a third UI component for switching between displaying and hiding the second UI component.

8. The manuscript submission system according to claim 6, wherein
in a case where contradictory conditions have been inputted on the order screen, the inputting unit further inputs, into the large language model, information indicating which of the conditions that have been inputted is to be given priority.

9. The manuscript submission system according to claim 1, wherein
when a correction instruction for the print setting that has been obtained from the large language model has been received from the user, the large language model is trained with correction content corresponding to the correction instruction.

10. The manuscript submission system according to claim 1, wherein
the processor is caused to further function as a presenting unit that, when a correction instruction for the print setting that has been obtained from the large language model has been received from the user, presents print setting change content based on the correction instruction.

11. An information processing apparatus comprising:
at least one processor; and
a memory coupled to the processor storing instructions that, when executed by the processor, cause the processor to function as:
an accepting unit that accepts, from a user, order information expressing a finish of printing in natural language;
an inputting unit that inputs a prompt based on the order information into a large language model; and
a display control unit that controls display of information based on a print setting which has been obtained from the large language model using the prompt as an input.

12. A control method for an information processing apparatus, the control method comprising:
an accepting step of accepting, from a user, order information expressing a finish of printing in natural language;
an inputting step of inputting a prompt based on the order information into a large language model; and
a display control step of controlling display of information based on a print setting which has been obtained from the large language model using the prompt as an input.
